(19) United States
(12) Patent Application Publication
(10) Pub. No.: US 2013/0141604 A1
(43) Pub. Date: Jun. 6, 2013

(54) IMAGE CAPTURING DEVICE AND METHOD FOR CAPTURING DETAILS OF ENTIRE SHOOTING SCENE

(71) Applicant: HONG-YU YANG, Shenzhen City (CN)

(72) Inventor: HONG-YU YANG, Shenzhen City (CN)

(73) Assignees: HON HAI PRECISION INDUSTRY CO., LTD., Tu-Cheng (TW); HONG FU JIN PRECISION INDUSTRY (Shenzhen) CO., LTD, Shenzhen City (CN)

(21) Appl. No.: 13/523,902

(22) Filed: Jun. 15, 2012

(30) Foreign Application Priority Data
Dec. 6, 2011 (CN) 201110400902.0

(51) Int. Cl. H04N 5/228; H04N 5/232

(52) U.S. Cl. 348/222.1; 348/E05.045; 348/E05.031

(57) ABSTRACT

An image capturing method implemented by an image capturing device includes determining a shooting scene of interest; dividing the shooting scene into a pre-set number of sub-areas; focusing on each of the pre-set number of sub-areas to have object(s) in each of the pre-set number of sub-areas clearly imaged with a corresponding focus setting, and capturing corresponding element images to produce the pre-set number of element images; associating all the element images together in a collection; and accessing any one of the element images according to a user input after the collection is accessed. The image capturing device is also provided.

### BACKGROUND

1. Technical Field

The present disclosure relates to image capturing devices and methods, and particularly, to an image capturing device and method fore capturing details of an entire shooting scene.

2. Description of Related Art

Cameras usually can focus on, other than an entire shooting scene, only an object of interest in the shooting scene. Accordingly, clearness of other objects in the same shooting scene may not be obtained. As such, it is difficult to check details of other objects, if needed.

### BRIEF DESCRIPTION OF THE DRAWINGS

Many aspects of the present embodiments can be better understood with reference to the drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a block diagram of an embodiment of an image capturing device, in accordance with the present disclosure.

FIG. 2 is a schematic diagram of a viewfinder of the image capturing device in FIG. 1, in accordance with the present disclosure.

FIG. 3 is a flowchart of an embodiment of an image capturing method implemented by the image capturing device in FIG. 1, in accordance with the present disclosure.

### DETAILED DESCRIPTION

Embodiments of the present disclosure will be described with reference to the accompanying drawings.

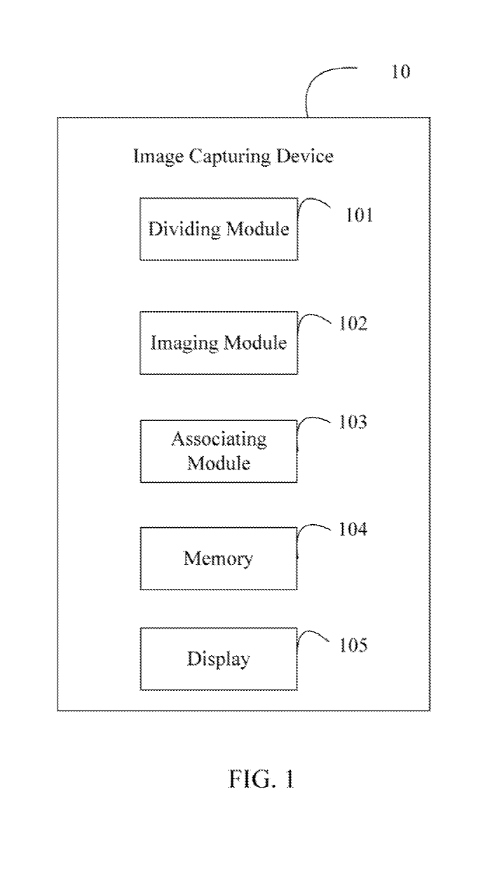

FIG. 1 is a block diagram of an embodiment of an image capturing device, in accordance with the present disclosure. The image capturing device 10 may be a camera. The image capturing device 10 includes a dividing module 101, an imaging module 102, an associating module 103, and a memory 104.

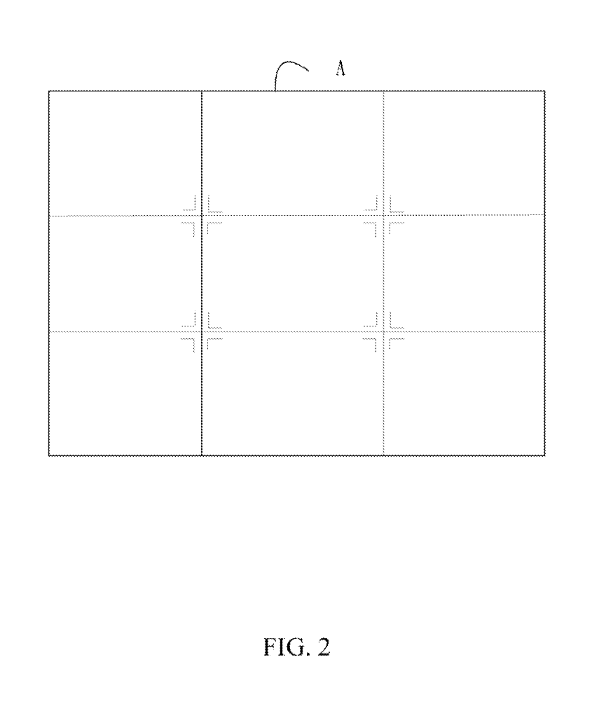

The dividing module 101 is used to divide a shooting scene into a pre-set number of sub-areas in an array form. In this embodiment, the image capturing device 10 has a display 105, the image capturing device 10 captures preview images and the previews images are displayed on the display 105. Thus, the display 105 can function as a viewfinder, and the user can use the display 105 to preview, and accordingly adjust the aim of the image capturing device 10 to determine a shooting scene of interest. The number of sub-areas may be inputted by the user or using default settings that are set in factory. The number may be 3*3, 4*4, or other numbers. As shown in FIG. 2, in this embodiment, the shooting scene A is divided into3*3 sub-areas. Objects in the whole shooting scene may have different object distances and thus can not be focused with a same focus setting. However, the shooting scene is divided such that object(s) in each sub-area is typically of the same object distance and thus object(s) in the same sub-area can be focused with a same focus setting.

The imaging module 102 includes an image sensor, such as CCD image sensor, and CMOS image sensor, is used to focus on each of the pre-set number of sub-areas and capture an image of object(s) in each of the pre-set number of sub-areas with a corresponding focus setting. That is, corresponding to the sub-areas, the imaging module 102 captures a pre-set number of element images with corresponding focus settings. The focus settings may be determined by various known technologies, like auto-focusing.

The associating module 103 is used to associate all the element images together in a collection. The collection can be stored as a file and provides links to the element image. When the file of the collection is accessed, one of the element images is accessed and displayed, showing details of the corresponding sub-area. However, the clearness of other sub-areas may be less than satisfactory. Therefore, the associating module 103 is also used to access any other one of the element images according to user inputs and drives the display to show the accessed element image. The user inputs are selections of the sub-area by, for example, a click, a slide on a part of the display 105 corresponding to the sub-area when the display 105 is a touch screen. The associating module 103 is further used to save the all the element images and the collection to the memory 104.

The memory 104 is used to supply space to all the element images and the collection.

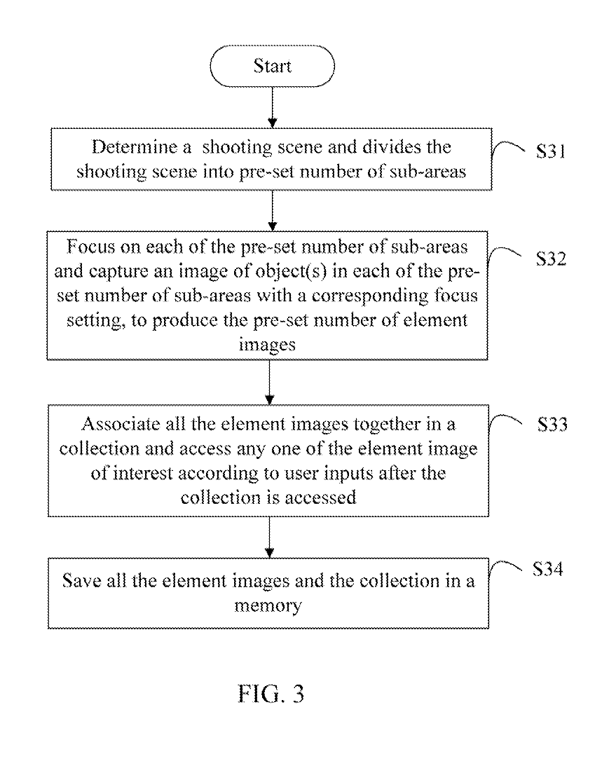

FIG. 3 is a flowchart of an embodiment of an image capturing method implemented by the image capturing device in FIG. 1, in accordance with the present disclosure.

In step S31, the dividing module 101 determines the shooting scene and divides the shooting scene into the pre-set number of sub-areas.

In step S32, the imaging module 102 focuses on each of the pre-set number of sub-areas and captures an image of object(s) in each of the pre-set number of sub-areas with a corresponding focus setting, to produce the pre-set number of element images.

In step S33, the associating module 103 associates all the element images together in the collection and accesses any one of the element image of interest according to user inputs after the collection is accessed.

In step S34, the associating module 103 saves all the element images and the collection in the memory 104.

As such, details of the whole shooting scenes are captured with typically more than one focus setting and can be accessed as needed.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. An image capturing device comprising:
a dividing module, to determine a shooting scene of interest, and divide the shooting scene into a pre-set number of sub-areas;
an imaging module, to focus on each of the pre-set number of sub-areas and capture an image of object(s) in each of the pre-set number of sub-areas with a corresponding focus setting, to produce the pre-set number of element images; and
an associating module, to associate all the element images in a collection and access any one of the element images according to a user input after the collection is accessed.

2. The image capturing device of claim 1, wherein the number of the sub-areas is inputted by the user or determined by default.

3. The image capturing device of claim 1, wherein the image capture device further comprising a display for showing the element images, the user input is a click or slide on a part of the touch screen corresponding to the sub-area of interest.

4. The image capturing device of claim 1, further comprising a memory, the associating module is further used to save the all the element images and the collection to the memory.

5. The image capturing device of claim 1, wherein the image capturing device is a camera.

6. An image capturing method implemented by an image capturing device, the method comprising:
determining a shooting scene of interest;
dividing the shooting scene into a pre-set number of sub-areas;
focusing on each of the pre-set number of sub-areas and capturing an image of object(s) in each of the pre-set number of sub-areas with a corresponding focus setting, to produce the pre-set number of element images;
associating all the element images together in a collection; and
accessing any one of the element images according to a user input after the collection is accessed.

7. The image capturing method of claim 6, wherein the number of the sub-areas is inputted by the user or determined by default.

8. The image capturing method of claim 6, wherein the user input is a click or slide on a part of a display of the image capturing device.

9. The image capturing method of claim 6, further comprising:
saving the all the element images and the collection to a memory of the image capturing device.

10. The image capturing method of claim 6, wherein the image capturing device is a camera.
